(19) United States
(12) Patent Application Publication
(10) Pub. No.: US 2026/0045740 A1
(43) Pub. Date: Feb. 12, 2026

(54) Actuator and Locking Device

(71) Applicant: Tokyo Parts Industrial Co., Ltd., Isesaki-shi (JP)

(72) Inventor: Kentaro FUJII, Isesaki-shi (JP)

(21) Appl. No.: 19/289,097

(22) Filed: Aug. 3, 2025

(30) Foreign Application Priority Data
Aug. 7, 2024 (JP) JP2024-131085

(51) Int. Cl. H01R 13/639; B60L 53/16; B60L 53/31

(52) U.S. Cl. CPC H01R 13/639; B60L 53/16; B60L 53/31

(57) ABSTRACT

A housing 11 of an actuator 10 presents a container-like shape with an open top. A protruding hole 12 is a cylindrical through hole protruding toward the exterior from the housing 11. A locking pin 13 is an approximately rod-shaped portion disposed so as to be able to advance toward, and retract from, the exterior, by way of the protruding hole 12. A stopper 14 is a member that is incorporated in the protruding hole 12 and has a predetermined thickness in the axial direction of the locking pin 13. The stopper 14 has a radially inwardly facing stopper inner surface 141 and a radially outwardly facing stopper outer surface 142. The stopper inner surface 141 does not ordinarily contact the locking pin 13 when no external force is acting on the locking pin 13.

### BACKGROUND OF THE INVENTION

The present invention relates to an actuator and a locking device.

In order to obtain drive power, electric automobiles and plug-in hybrid automobiles are equipped with large onboard batteries. In order to charge the onboard battery, an external connector, which is connected to an external power source, and a vehicle-side connector, which is provided on the vehicle side, must be connected. Furthermore, a locking mechanism is provided, in order that, in the connected state, the external connector and the vehicle-side connector do not inadvertently separate.

When charging an electric automobile or plug-in hybrid automobile, the vehicle is first parked in the vicinity of a charging facility, and the external connector of the charging facility and the vehicle-side connector are connected. Further, the locking mechanism locks the external connector and the vehicle-side connector. Thereafter, power is supplied from the external power source to the onboard battery to charge the onboard battery.

When charging has ended, after releasing locking by the locking mechanism, the external connector is removed from the vehicle-side connector.

Furthermore, as described in Japanese Patent Laid-Open Publication No. 2012-181985, a locking device provided with a locking member, serving to prevent inadvertent release of a locking mechanism, has also been developed. In the locking device described in Japanese Patent Laid-Open Publication No. 2012-181985, the locking member and a lock actuator, which operates this, are provided on a vehicle body. A vehicle body-side connector has a locking part. A cable-side connector has an engagement part that can be engaged with this locking part. In the state in which the engagement part is in the engaged position, engaged with the locking part, removal of the cable-side connector is restricted. Furthermore, when the locking member is in the locked position, movement of the engagement part from the engaged position to the disengaged position is restricted. On the other hand, when the locking member is in the unlocked position, movement of the engagement part between the engaged position and the disengaged position is permitted.

However, in the locking device described in Japanese Patent Laid-Open Publication No. 2012-181985, there was room for improvement from the viewpoint of protecting the lock actuator from damage.

Specifically, when the locking pin is in the locked position, if an attempt is made to aggressively move the engagement part in the release direction by forcibly operating the operating knob (release button) on the cable-side connector, excessive stress will act on the locking pin. As a result, there was a risk of deformation of, or damage to, the locking pin and actuator body.

### SUMMARY OF THE INVENTION

One or more working examples of the present invention have been made in view of such problems, and it is an object of the present invention to provide an actuator and a locking device capable of protecting a locking pin in a locked position and an actuator body from damage.

An embodiment of the actuator of the present invention comprises a housing having: a through hole; a locking pin, which is disposed so as to be able to advance toward, and retract from, the exterior, by way of the through hole; and a stopper, which is incorporated in the through hole and has a predetermined thickness in the axial direction of the locking pin, the stopper having a stopper inner surface, facing radially inward and facing the locking pin, and a stopper outer surface facing radially outward, the stopper inner surface not ordinarily contacting the locking pin when no external force is acting on the locking pin, and the stopper outer surface being in surface contact with a through hole inner surface, which is a surface of the through hole that faces inward.

Furthermore, in another embodiment of the actuator of the present invention the through hole is a protruding hole protruding toward the exterior from the housing.

Furthermore, in another embodiment of the actuator of the present invention, a seal member is disposed inside the protruding hole, closer to the housing than the stopper.

Furthermore, in another embodiment of the actuator of the present invention, the stopper is disposed inside the through hole by press fitting.

Furthermore, in another embodiment of the actuator of the present invention, the stopper is made of metal.

Furthermore, in another embodiment of the actuator of the present invention, the thickness of the stopper in the axial direction of the locking pin is 0.5 mm or more.

Furthermore, in another embodiment of the actuator of the present invention, the thickness of the stopper in the axial direction of the locking pin is 0.8 mm or more.

Furthermore, in another embodiment of the actuator of the present invention, the thickness of the stopper in the axial direction of the locking pin is 1.0 mm or more.

Furthermore, in another embodiment of the actuator of the present invention, the stopper presents an approximate ring shape, the locking pin passing through the interior thereof.

Furthermore, a locking device according to an embodiment of the present invention is a locking device that locks an external-side connector and a vehicle-side connector, comprising: an external-side engagement part disposed on the external-side connector; a vehicle body-side locking part disposed on the vehicle-side connector; and the actuator of the present invention, a locked state resulting from the external-side engagement part engaging with the vehicle body-side locking part and the locking pin of the actuator extending in the vicinity of the external-side engagement part.

With the actuator of the present invention, in a state in which an external force acts on the locking pin, the locking pin contacts the stopper inner surface. The stopper can thereby support the middle portion of the locking pin and mitigate the bending stress acting on the through hole of the actuator and the like. Furthermore, in a state in which an external force acts on the locking pin, the outer surface of the stopper and the inner surface of the through hole are in surface contact, whereby the stress transmitted from the outer surface of the stopper to the inner surface of the through hole is dissipated, making it possible to prevent deformation of, and damage to, the through hole.

With the locking device of the present invention, the locking pin of the actuator extending in the vicinity of the external-side engagement part can limit the movement of the external-side engagement part and prevent the locked state of the locking device from being inadvertently released. Inadvertent separation of the external-side connector and the vehicle-side connector while charging the rechargeable battery that is installed in the vehicle can thereby be prevented.

### BRIEF DESCRIPTION OF THE DRAWINGS

FIG. 1A is a side view illustrating the disconnected state in an embodiment of the present invention.

FIG. 1B is a side view illustrating the connected state and the unlocked state in an embodiment of the present invention.

FIG. 1C is a side view illustrating the connected state and the locked state in an embodiment of the present invention.

FIG. 2 is a perspective view illustrating an actuator according to an embodiment of the present invention.

FIG. 3 is an exploded perspective view illustrating an actuator according to an embodiment of the present invention.

FIG. 4A is a sectional view illustrating an actuator according to an embodiment of the present invention.

FIG. 4B is an enlarged sectional view illustrating an actuator according to an embodiment of the present invention.

FIG. 5A is a sectional view illustrating a protruding hole of an actuator according to an embodiment of the present invention.

FIG. 5B is a perspective view illustrating a protruding hole of an actuator according to an embodiment of the present invention.

FIG. 6 is a sectional view illustrating a situation in which an external force is acting on the locking pin of an actuator according to an embodiment of the present invention.

FIG. 7A is a sectional view illustrating a protruding hole of an actuator according to a comparative example.

FIG. 7B is a sectional view illustrating a protruding hole of an actuator according to an embodiment of the present invention.

FIG. 8 is a graph illustrating the effects of actuators according to embodiments of the present invention.

### DETAILED DESCRIPTION OF THE PREFERRED EMBODIMENTS

Hereafter, embodiments of the present invention will be described in detail based on the drawings. In the following description, the same members are, in principle, given the same reference numerals, and repeated descriptions are omitted. In the following description, when descriptions are made using the up, down, front, back, left, and right directions, these directions serve for convenience of explanation. Furthermore, left-right is the direction in which the external-side connector 22, which will be described below, is inserted and removed with respect to the vehicle-side connector 21. Furthermore, the left is the vehicle external side, and the right is the vehicle interior side.

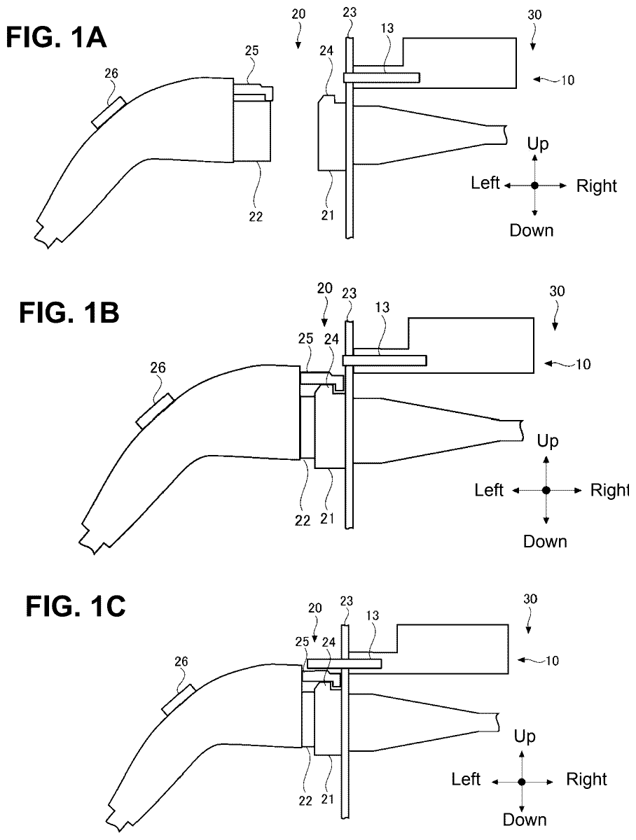

A locking device 20 according to the present embodiment will be described, referring to FIG. 1A to FIG. 1C. FIG. 1A is a side view illustrating the disconnected state. FIG. 1B is a side view illustrating the connected state and the unlocked state. FIG. 1C is a side view illustrating the connected state and the locked state. Here, the connected state is a state in which the vehicle-side connector 21 and the external-side connector 22 are electrically connected. The disconnected state is a state in which the vehicle-side connector 21 and the external-side connector 22 are not electrically connected. The locked state is a state in which the engagement of a vehicle body-side locking part 24 and an external-side engagement part 25, which will be described below, is locked by a locking pin 13.

Referring to FIG. 1A, the locking device 20 is a device that locks the external-side connector 22 and the vehicle-side connector 21. The locking device 20 mainly comprises the external-side engagement part 25, which is disposed on the external-side connector 22, a vehicle body-side locking part 24, which is disposed on the vehicle-side connector 21, and an actuator 10. As will be described below, a locked state results from connecting vehicle-side connector 21 and the external-side connector 22, engaging the external-side engagement part 25 with the vehicle body-side locking part 24, and extending the locking pin 13 of the actuator 10 in the vicinity of the external-side engagement part 25 to prevent the external-side engagement part 25 from disengaging.

The vehicle-side connector 21 is a connector provided on the vehicle body 23 for the purpose charging a battery, which is not shown, installed in the vehicle 30. A vehicle body-side locking part 24 is formed in the vicinity of the upper end of the vehicle-side connector 21. The vehicle body-side locking part 24 is an upwardly protruding protrusion. Furthermore, the lateral surface of the vehicle body-side locking part 24 that faces the external-side engagement part 25 is an inclined surface, which is inclined upward to the right. Here, the vehicle 30 is a vehicle provided with a rechargeable battery for generating a drive force such as, for example, an EV (Electric Vehicle), a PHV (Plug-In Hybrid Vehicle), or the like.

The external-side connector 22 is a connector provided at an end of a cable that extends from a power supply facility installed externally, which is not shown, for the purpose of supplying power to the battery installed in the vehicle 30. The external-side connector 22 has the external-side engagement part 25 and a knob 26.

The external-side engagement part 25 is an engagement part disposed on the upper right end of the external-side connector 22. The external-side engagement part 25 is rotatable, with the left end thereof as the center of rotation. Furthermore, the external-side engagement part 25 is biased in the clockwise direction by a spring or the like, which is not shown.

The knob 26 is provided so as to be capable of being pushed in against the external-side connector 22. The knob 26 and the external-side engagement part 25 are configured so as to be linked. That is to say, while the user is not operating the knob 26, the external-side engagement part 25 is in the state illustrated in FIG. 1A. On the other hand, when the user pushes in the knob 26, the external-side engagement part 25 tilts in counterclockwise rotation, which is to say, tilts upward to the right.

The actuator 10 is a device disposed in the vicinity of the vehicle-side connector 21 on the side of the vehicle body 23. As will be described below, the actuator 10 has a locking pin 13. The locking pin 13 can advance and retract in the left-right direction. A locked state that prevents disengagement of the external-side engagement part 25 results from the locking pin 13 extending to the left. On the other hand, an unlocked state that permits disengagement of the external-side engagement part 25 results from the locking pin 13 moving to the right. The actuator 10 uses the drive force of a motor incorporated in the actuator 10, which is not shown, to move the locking pin 13 in the left-right direction, based on the instructions of a computational control part, which is a CPU or the like, which is not shown here.

Referring to FIG. 1B, when the user inserts the external-side connector 22 into the vehicle-side connector 21, the external-side engagement part 25 engages the vehicle body-side locking part 24. As mentioned above, the left lateral surface of the vehicle body-side locking part 24 is an inclined lateral surface. Furthermore, the external-side engagement part 25 is biased in the clockwise direction. Thus, when the external-side connector 22 is inserted into the vehicle-side connector 21, after tilting along the inclined lateral surface of the vehicle body-side locking part 24, the external-side engagement part 25 engages the vehicle body-side locking part 24.

Referring to FIG. 1C, after the external-side engagement part 25 engages the vehicle body-side locking part 24, the locking pin 13 moves to the left, based on a user operation or a computational control part instruction. The locking device 20 is thereby in the locked state. In the locked state, the left-side part of the locking pin 13 is disposed in the vicinity of on the upper side of the external-side engagement part 25. Thus, even if the user pushes the knob 26 in an accidental operation and, as a result, the external-side engagement part 25 attempts to rotate counterclockwise and lift the tip of the external-side engagement part 25, because the locking pin 13 presses onto the external-side engagement part 25, there will be substantially no lifting of the external-side engagement part 25. Thus, the engaged state between the vehicle body-side locking part 24 and the external-side engagement part 25 is maintained, even if such an accidental operation occurs. Thus, the locked state of the locking device 20 can be prevented from being inadvertently released. This can prevent inadvertent separation of the external-side connector 22 and the vehicle-side connector 21 while charging the rechargeable battery that is installed in the vehicle 30.

As will be described below, even if an external force that lifts the left end of the locking pin 13 upward acts due to an attempt to raise the external-side engagement part 25, a stopper 14, which will be described below, is incorporated into the actuator 10 whereby deformation of, or damage to, the actuator 10 due to such external force is prevented.

In such a locked state, charging of the onboard battery installed in the vehicle 30 is performed. After this charging has ended, the locking pin 13 moves to the right, based on a user operation or a computational control part instruction. This places the locking device 20 in the unlocked state illustrated in FIG. 1B. In this state, when the user pushes in the knob 26, the external-side engagement part 25 rotates counterclockwise, thereby releasing the engagement of the external-side engagement part 25 and the vehicle body-side locking part 24. Furthermore, the connection between the vehicle-side connector 21 and the external-side connector 22 is released by the user pulling the external-side connector 22 to the left. The vehicle 30 is thereby in a drivable state.

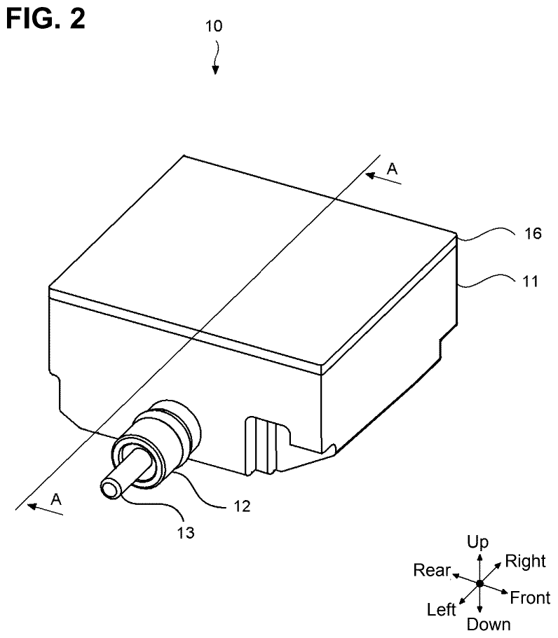

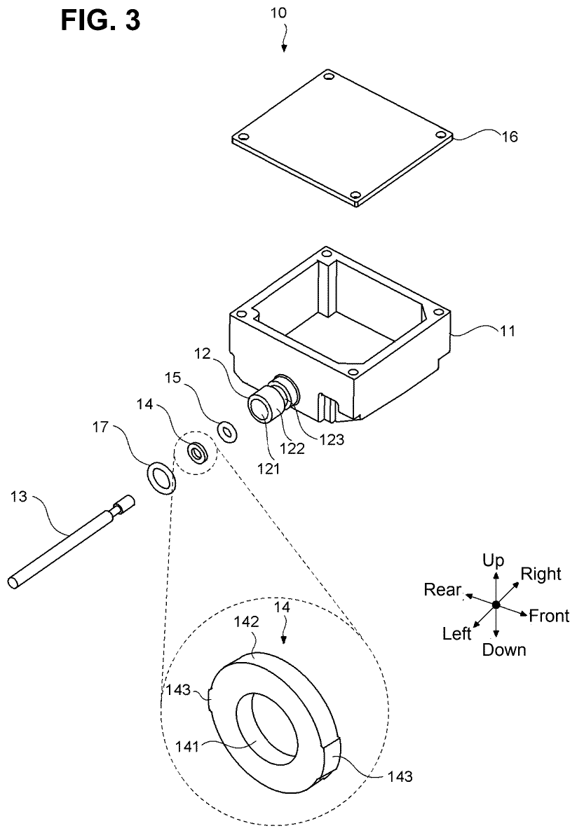

FIG. 2 is a perspective view illustrating the actuator 10. FIG. 3 is an exploded perspective view illustrating the actuator 10. In the portion enclosed by the dotted line in FIG. 3, a stopper 14 is shown enlarged.

The actuator 10 mainly comprises a housing 11, a protruding hole 12, the locking pin 13, and the stopper 14. The actuator 10 can be placed in the locked state and the unlocked state, as mentioned above.

Referring to FIG. 3, the housing 11 is the body of the actuator 10 and presents a container-like shape with an open top. The top opening of the housing 11 is covered by a lid member 16. A drive mechanism, which is not shown, is disposed inside the housing 11 for moving the locking pin 13. The drive mechanism includes, for example, a motor, a gear, and the like. A synthetic resin including glass fibers is, for example, employed as the material for the housing 11.

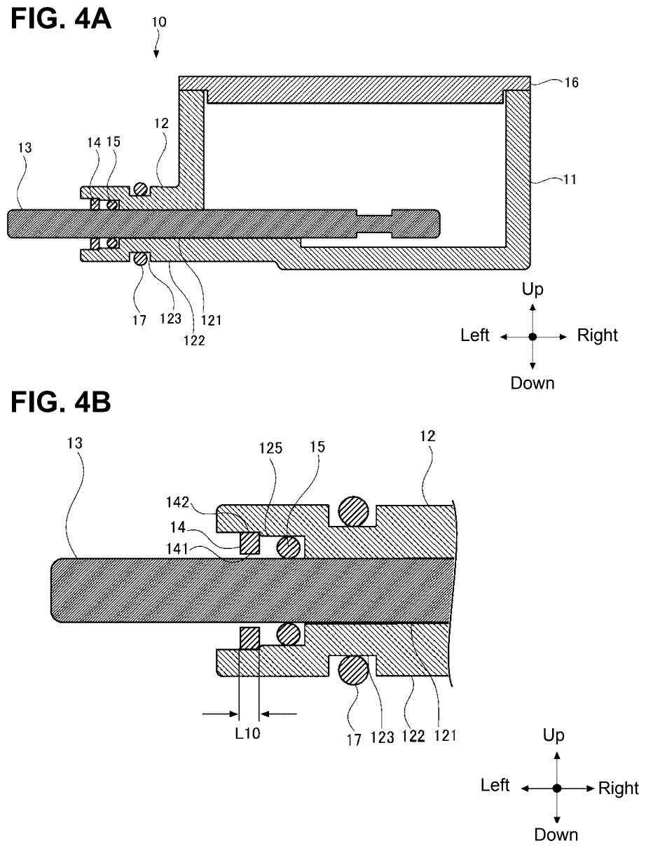

The protruding hole 12 is a cylindrical portion protruding toward the exterior from the housing 11. The protruding hole 12 is a member that is integrally continuous with the housing 11. The protruding hole 12 and the housing 11 are formed, for example, by injection molding. The protruding hole 12 has a seamless, non-divided structure. The protruding hole 12 presents an approximately cylindrical shape, for example. The interior of the protruding hole 12 communicates with the interior of the housing 11. The protruding hole 12 corresponds to the through hole in the present embodiment. The protruding hole 12 has a protruding hole inner surface 121 and a protruding hole outer surface 122, and a protruding hole groove 123 is formed in the protruding hole outer surface 122. The specific configuration of the protruding hole 12 will be described below with reference to FIG. 4A and the like.

A locking pin 13 is an approximately cylindrical portion disposed so as to be able to advance toward, and retract from, the exterior, by way of the protruding hole 12. A highly rigid metal, such as SUS, for example, is employed as the material for the locking pin 13.

A first seal member 15 is disposed inside the protruding hole 12. A second seal member 17 is disposed outside the protruding hole 12. O-rings or the like are employed as the first seal member 15 and the second seal member 17. The first seal member 15 and the second seal member 17 are described below with reference to FIG. 4A and the like.

The stopper 14 is a member that is incorporated in the protruding hole 12 and has a predetermined thickness in the axial direction of the locking pin 13. The stopper 14 presents an approximately circular ring shape, the locking pin 13 passing through the interior thereof. Referring to the part surrounded by the dotted line in FIG. 3, the stopper 14 has a stopper inner surface 141 facing radially inward and facing the side surface of the locking pin 13 and a stopper outer surface 142 facing radially outward. Because the stopper 14 presents an approximately circular ring shape, in a state in which an external force acts on the locking pin 13, the stopper 14 can firmly hold the locking pin 13. Furthermore, opposing ends of the stopper outer surface 142 are made to protrude slightly radially outward to form protrusions 143.

The stopper 14 is made of a highly rigid metal such as, for example, SUS. Because the stopper 14 is made of metal, in a state in which an external force acts on the locking pin 13, the intermediate part of the locking pin 13 can be held firmly by the stopper 14. Furthermore, wear of, and damage to, both the locking pin 13 and the stopper 14 due to contact therebetween can be prevented.

FIG. 4A is a sectional view illustrating the actuator 10. FIG. 4B is an enlarged sectional view illustrating the actuator 10. FIGS. 4A and 4B are sectional views at the A-A section line in FIG. 2. The A-A section is a section including the up-down direction and the left-right direction. Such matters are the same for the following sectional views.

Referring to FIGS. 4A and 4B, the protruding hole 12 has a protruding hole inner surface 121 and a protruding hole outer surface 122. The protruding hole inner surface 121 is the radially inwardly facing side surface of the protruding hole 12. The protruding hole outer surface 122 is the radially outwardly facing surface of the protruding hole 12. The protruding hole groove 123 is a portion resulting from radially inwardly recessing the protruding hole outer surface 122. A second seal member 17 is disposed in the protruding hole groove 123. The second seal member 17 is a member that improves sealing with another member comprised by the vehicle 30 at the radial outside of the protruding hole 12, and prevents water from entering.

The first seal member 15 and the stopper 14 are disposed inside the protruding hole 12. Inside the protruding hole 12, the first seal member 15 is disposed on the side that is closer to the housing 11 than the stopper 14, which is to say, to the right. The stopper 14 can prevent the first seal member 15 from disengaging from the protruding hole 12.

The first seal member 15 is disposed in a first expanded diameter part 125 formed inside the protruding hole 12. The outer portion of the first seal member 15 contacts the first expanded diameter part 125 and the inner portion of the first seal member 15 contacts the side surface of the locking pin 13. A seal is thereby made between the protruding hole 12 and the locking pin 13, preventing water from entering the housing 11 via the space between the two.

The stopper 14 is disposed inside the protruding hole 12, to the left of the first seal member 15. The stopper 14 is a member that prevents the first seal member 15 from disengaging from the protruding hole 12. The stopper inner surface 141 does not ordinarily contact the locking pin 13 when no external force is acting on the locking pin 13. Over substantially the entire surface thereof, the stopper outer surface 142 is in surface contact with the protruding hole inner surface 121, which is the inwardly facing surface of the protruding hole 12. As will be described below, when an external force acts on the locking pin 13, the deformed locking pin 13 comes into surface contact with the stopper inner surface 141 of the stopper 14.

The thickness L10 of the stopper 14 in the axial direction of the locking pin 13 is preferably 0.5 mm or more, more preferably 0.8 mm or more, and particularly preferably 1.0 mm or more. In this manner, the stopper 14 can support the middle portion of the locking pin 13 and prevent deformation of, and damage to, the protruding hole 12, even if acted on by an external force that lifts the left end of the locking pin 13 upward, as will be described below.

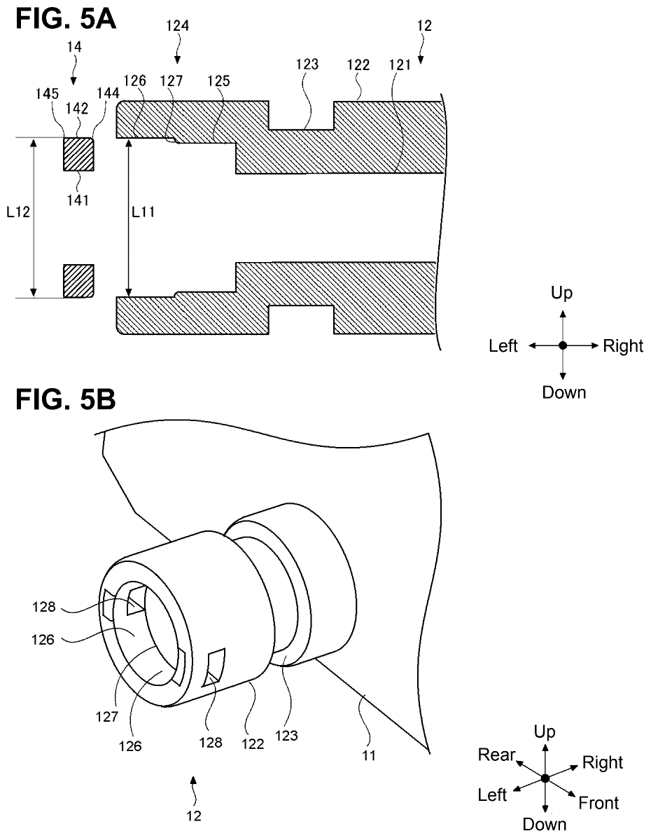

FIG. 5A is a sectional view illustrating the protruding hole 12 of the actuator 10. FIG. 5B is a perspective view illustrating the protruding hole 12 of the actuator 10.

Referring to FIG. 5A, the left end of the protruding hole 12 serves as the protruding hole expanded diameter part 124. The protruding hole expanded diameter part 124 has a first expanded diameter part 125 and a second expanded diameter part 126. The first expanded diameter part 125 is a portion in which the protruding hole inner surface 121 has been expanded, on the left. The second expanded diameter part 126 is a portion in which the protruding hole inner surface 121 is further expanded, to the left of the first expanded diameter part 125. A step 127 is formed between the first expanded diameter part 125 and the second expanded diameter part 126. The step 127 forms a left facing surface.

The diameter L11 of the second expanded diameter part 126 is slightly smaller than the diameter L12 of the stopper 14. In this manner, when the stopper 14 is received in the protruding hole 12, the stopper outer surface 142 of the stopper 14 can be brought into close contact with the second expanded diameter part 126 of the protruding hole 12 to firmly fix the position of the stopper 14 within the protruding hole 12. Further, the stopper 14 is disposed inside the protruding hole 12 by press fitting. This also allows the stopper 14 to be more firmly fixed at a predetermined position inside the protruding hole 12.

The stopper 14 is a member formed by punching out a metal plate made of SUS or the like. The outer periphery 144 on the right of the stopper 14 consequently presents a sloped shoulder shape. On the other hand, at the outer periphery 145 on the left side of the stopper 14, a slight burr is formed facing the left. Thus, when press fitting the stopper 14 into the second expanded diameter part 126 of the protruding hole 12, the outer periphery 144 of the stopper 14 has a sloped shoulder shape, which facilitates press fitting. Furthermore, when press fitting ends, the burr formed in the outer periphery 145 of the stopper 14 bites into the inner surface of the second expanded diameter part 126, whereby the stopper 14 can be prevented from falling out or the like.

Referring to FIG. 5B, openings 128 are formed by passing through the protruding hole 12 in portions where the second expanded diameter part 126 is formed. The openings 128 are formed in opposing portions of the protruding hole 12. The openings 128 receive the protrusions 143 of the stopper 14, shown in FIG. 3. In this manner, the position of the stopper 14 can be more firmly fixed inside the protruding hole 12.

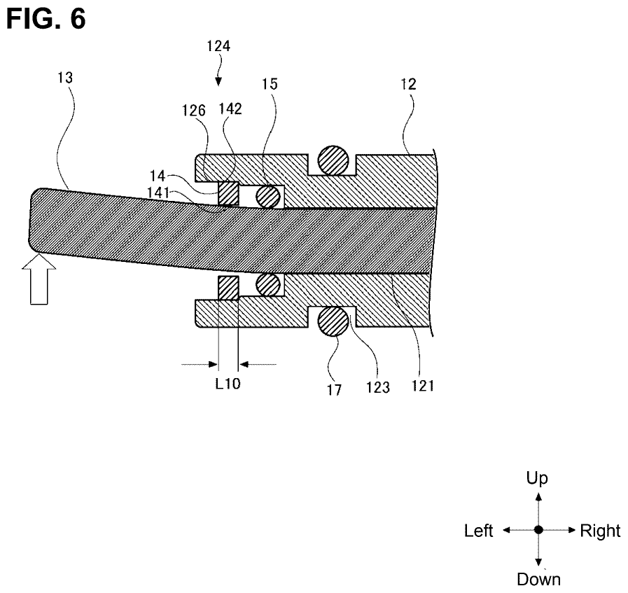

FIG. 6 is a sectional view illustrating a situation in which an external force is acting on the locking pin 13 of the actuator 10.

When a user operates the knob 26 by mistake, in the locked state shown in FIG. 1C, the tip of the external-side engagement part 25 is lifted and an external force is generated that attempts to push the locking pin 13 up from below.

In FIG. 6, this external force is indicated by the arrow. When such an external force acts, the left end part of the locking pin 13 is deformed upward. In conjunction with this deformation, the middle portion of the locking pin 13 contacts the stopper inner surface 141 of the stopper 14.

As mentioned above, the stopper 14 is a member with at least a predetermined thickness in the axial direction of the locking pin 13. Thus, when the locking pin 13 is deformed, the stopper inner surface 141 of the stopper 14 makes surface contact with the locking pin 13 across a wide range. Therefore, the stress produced by the deformation of the locking pin 13 is mitigated by the stopper 14, which has the predetermined thickness. Thus, the stress produced by the external force on the locking pin 13 is prevented from being directly transmitted to the protruding hole 12, such that deformation of, and damage to, the protruding hole 12 can be prevented.

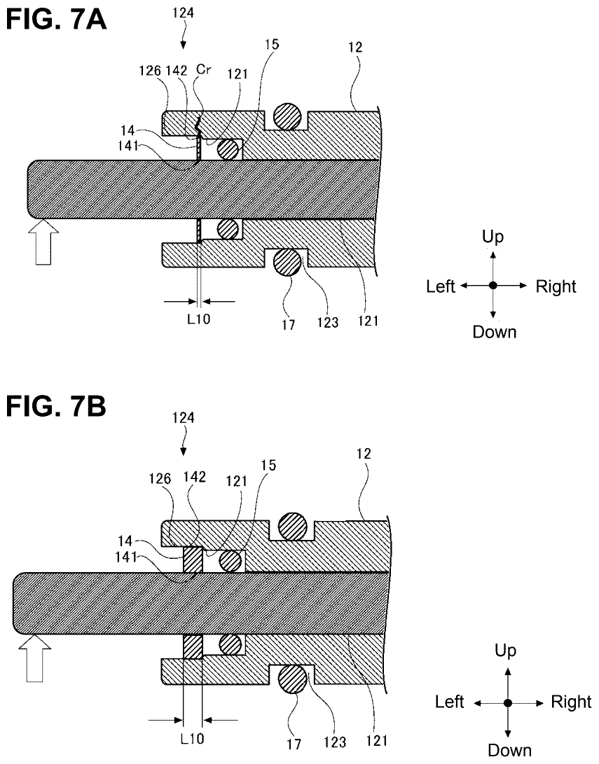

Furthermore, as shown in FIG. 7A, if the stopper 14 does not have at least the predetermined thickness (for example, if the thickness L10 of the stopper 14 is approximately 0.1 to 0.3 mm), when the external force indicated by the arrow acts on the locking pin 13, the stopper outer surface 142 of the stopper 14 will bite sharply into the protruding hole inner surface 121, resulting in damage such as a crack Cr in the protruding hole inner surface 121. On the other hand, as shown in FIG. 7B, when the stopper 14 has the predetermined thickness or more, the stress transmitted from the stopper outer surface 142 to the protruding hole inner surface 121 is dispersed due to the wide surface contact between the stopper outer surface 142 and the protruding hole inner surface 121, thereby preventing deformation of, or damage to, the protruding hole 12.

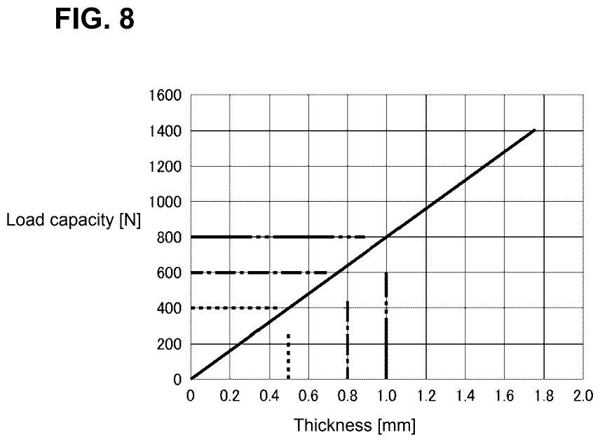

FIG. 8 is a graph showing the relationship between the thickness L10 of the stopper 14 and the load capacity. In the graph in FIG. 8, the horizontal axis shows the thickness L10 of the stopper 14, and the vertical axis shows the load capacity at that thickness L10. Note that the load capacity refers to the load at which deformation of, and damage to, the protruding hole 12 does not occur when an upward external force (arrow in FIGS. 6, 7A and 7B) is applied to the tip of the locking pin 13.

Here, by setting the tensile strength of the resin constituting the protruding hole 12 to be 140 MPa and further setting the safety factor to 1.3, the tensile strength of the resin constituting the protruding hole 12 is conveniently set to 110 MPa (=N/mm2). Furthermore, the material constituting the stopper 14 is punched SUS304, and the material constituting the locking pin 13 is machined SUS303. Further, the diameter L12 of the stopper 14 is set to 7.3 mm, and the thickness L10 in the axial direction of the stopper 14 is varied between 0 mm and 2.0 mm. Then, the diameter L12 of the stopper 14 is multiplied by the thickness L10 to calculate the projected area between the stopper outer surface 142 and the protruding hole inner surface 121. Furthermore, by multiplying this projected area by the tensile strength of the resin that was conveniently obtained, the load capacity between the stopper outer surface 142 and the protruding hole inner surface 121 is calculated. The results of these calculations are graphed in FIG. 8.

According to regulations for vehicle safety, the load capacity between the stopper outer surface 142 and the protruding hole inner surface 121 must be 330N or more.

As described above, the thickness L10 of the stopper 14 in the present embodiment is, for example, 0.5 mm or more, 0.8 mm or more, or 1.0 mm or more. As can be read from the graph, if the thickness L10 of the stopper 14 is 0.5 mm, the load capacity is approximately 400 N, which can satisfy the safety regulations. Furthermore, when the thickness L10 of the stopper 14 is 0.8 mm, the load capacity is approximately 600 N. This is equivalent to approximately 1.5 times the safety regulations, such that a margin can be ensured for the safety regulations. Furthermore, when the thickness L10 of the stopper 14 is 1.0 mm, the load capacity is approximately 800 N. This is more than twice the safety regulations, such that a sufficient margin can be ensured for the safety regulations.

Thus, in the present embodiment, by setting the thickness L10 of the stopper 14 to 0.5 mm or more, 0.8 mm or more, or 1.0 mm or more, a load capacity that can fully satisfy the safety regulations can be obtained, and the effect of mitigating the bending stress acting on the locking pin and the effect of preventing the locking pin, the stopper, and the protruding hole from being damaged can be achieved to a remarkable extent.

Although embodiments of the present invention have been described above, the present invention is not limited thereto and can be modified without departing from the gist of the present invention. Furthermore, the embodiments described above can be combined with each other.

For example, in the description referring to FIG. 3 and the like, the locking pin 13 and the stopper 14 were incorporated in the protruding hole 12, but there is no limitation to this. As long as the stopper 14, which has a predetermined thickness L10 is of a shape that can be incorporated, a simple through hole may be used.

For example, in the description referring to FIG. 4B, one stopper 14 was provided in the protruding hole 12, but a plurality of stoppers 14 can be provided overlaid in the thickness direction. When a plurality of stoppers 14 are present, the sum of the thicknesses of the plurality of stoppers 14 is, for example, 0.5 mm or more, 0.8 mm or more, or 1.0 mm or more.

Furthermore, referring to FIG. 3, the shape of the stopper 14 can be other than an approximately circular ring. For example, the locking pin 13 may have a rectangular sectional shape and the stopper 14 may have a rectangular ring shape. The shape of the stopper 14 can also have an approximately circular ring shape in the upper half. In this manner, the locking pin 13 can be supported by the stopper 14 presenting an approximately circular ring shape in the upper half.

Furthermore, referring to FIG. 5A, the stopper 14 can also be fixed by a method other than press fitting. For example, the stopper 14 can be fixed in the second expanded diameter part 126 of the protruding hole 12 by interlocking, adhesion, or the like.

Referring to FIG. 3, a material other than metal may also be employed as the material for the locking pin 13 and the stopper 14. For example, a highly rigid resin can be employed as the material for the locking pin 13 and the stopper 14.

Referring to FIGS. 1A to 1C, the direction of insertion and removal of the external-side connector 22 and the direction in which the locking pin 13 protrudes were both the left-right direction. Here, the direction of insertion and removal of the external-side connector 22 and the direction in which the locking pin 13 protrudes may be different. For example, the direction of insertion and removal of the external-side connector 22 can be the left-right direction, and the direction in which the locking pin 13 protrudes can be the up-down direction.

What is claimed is:

1. An actuator, comprising:
a housing having a through hole;
a locking pin, which is disposed so as to be able to advance toward, and retract from, the exterior, by way of the through hole; and
a stopper, which is incorporated in the through hole and has a predetermined thickness in the axial direction of the locking pin,
the stopper having a stopper inner surface, facing radially inward and facing the locking pin, and a stopper outer surface facing radially outward,
the stopper inner surface not ordinarily contacting the locking pin when no external force is acting on the locking pin, and
the stopper outer surface being in surface contact with a through hole inner surface, which is a surface of the through hole that faces inward.

2. The actuator according to claim 1,
wherein the through hole is a protruding hole protruding toward the exterior from the housing.

3. The actuator according to claim 2,
wherein a seal member is disposed inside the protruding hole, closer to the housing than the stopper.

4. The actuator according to claim 1,
wherein the stopper is disposed inside the through hole by press fitting.

5. The actuator according to claim 1,
wherein the stopper is made of metal.

6. The actuator according to claim 1,
wherein the thickness of the stopper in the axial direction of the locking pin is 0.5 mm or more.

7. The actuator according to claim 1,
wherein the thickness of the stopper in the axial direction of the locking pin is 0.8 mm or more.

8. The actuator according to claim 1,
wherein the thickness of the stopper in the axial direction of the locking pin is 1.0 mm or more.

9. The actuator according to claim 1,
wherein the stopper presents an approximate ring shape, the locking pin passing through the interior thereof.

10. A locking device that locks an external-side connector and a vehicle-side connector, comprising:
an external-side engagement part disposed on the external-side connector;
a vehicle body-side locking part disposed on the vehicle-side connector; and
an actuator according to claim 1,
a locked state resulting from the external-side engagement part engaging with the vehicle body-side locking part and the locking pin of the actuator extending in the vicinity of the external-side engagement part.
